(19) United States
(12) Patent Application Publication
(10) Pub. No.: US 2022/0268635 A1
(43) Pub. Date: Aug. 25, 2022

(54) METHOD AND DEVICE FOR MONITORING RADIATION

(71) Applicant: trinamiX GmbH, Ludwigshafen am Rhein (DE)

(72) Inventors: Stefan Hoos, Ludwigshafen (DE); Celal Mohan Oeguen, Ludwigshafen (DE); Robert Send, Karlsruhe (DE)

(21) Appl. No.: 17/628,005

(22) PCT Filed: Jul. 17, 2020
(86) PCT No.: PCT/EP2020/070275

§ 371 Date: Jan. 18, 2022

(30) Foreign Application Priority Data
Jul. 19, 2019 (EP) 19187373.6

(51) Int. Cl. G01J 5/60; G01J 5/80

(52) U.S. Cl. CPC G01J 5/60; G01J 5/80; G01J 2005/608

(57) ABSTRACT

Described herein is a method and a device for monitoring radiation emitted by a radiation emitting element of a thermal radiation source within the visible and the infrared spectral ranges, specifically for determining an emission spectrum of the thermal radiation source. The method includes the following steps: a) providing a thermal radiation source including a radiation emitting element; b) providing at least one radiation sensitive element; c) measuring a spectral radiance of the radiation emitted by the radiation emitting element at at least two individual wavelengths; and d) determining an emission temperature of the radiation emitting element by providing a ratio of the measured values of the spectral radiance of the radiation at the at least two individual wavelengths.

### FIELD OF THE INVENTION

The invention relates to a method and a device for monitoring radiation emitted by a thermal radiation source, in particular by an incandescent lamp or a thermal infrared emitter, within the visible and the infrared spectral ranges, specifically for determining an emission spectrum of the thermal radiation source. Further, the invention relates to a computer program product which comprises executable instructions for performing the method. The method, the computer program product, and the device can be used for monitoring various operational modes of a thermal radiation source, specifically in a spectroscopic application, particularly, in the visible and the infrared spectral ranges, in which the thermal radiation source may, preferably, be used as illumination source.

### Prior Art

Various methods and devices for monitoring radiation, such as for light within the visible and the infrared spectral ranges, are known and have, in particular, been used for a determination of an emission spectrum of a wire filament comprised by an incandescent lamp. Herein, filament temperatures are, typically, in a range of 2000 to 3300 K, thus, resulting in a light emission which is predominantly within the visible and the infrared spectral ranges. Further, these methods and devices may also be used for monitoring the radiation of other thermal radiation sources, especially of thermal infrared emitters.

Incandescent lamps, in the following also abbreviated to “lamp”, are, typically, used nowadays in sample illumination in infrared spectrometers, in particular since they exhibit an emission of infrared light over a broad wavelength range. As an alternative, thermal infrared emitters may be used for this purpose. As an approximation, the radiation emitted by of the thermal radiation source can be reasonably estimated by using Planck's law of black body radiation. Herein, the temperature T given by Planck's law, which is described below in more detail, corresponds to the temperature of a radiation emitting element in the thermal radiation source, such as a wire filament in the incandescent lamp or a radiation emitting surface in the thermal infrared emitter. However, the temperature of the radiation emitting element may, further, depend on various factors including but not limited to outside temperature, battery status, lifetime, time of overall use, time since operation, or manufacturing details of the thermal radiation source. Thus, in general, it is not straightforward to control the actual emission of the thermal radiation source by simply controlling a current or a voltage being used for operating the thermal radiation source, or, alternatively, by measuring a brightness of the thermal radiation source.

In general, the emission spectrum of the thermal radiation source which can be considered as a background spectrum is recorded prior to recording the spectrum of interest. This kind of procedure allows compensating any changes of the emission of the thermal radiation source.

For this purpose, the current and voltage which are used for operating the incandescent lamp can be measured in order to determine a resistance R of the lamp, specifically of the wire filament, which, typically, comprises tungsten. Since the resistance R of a metal wire filament can be approximated by a non-linear function of the temperature T, such as expressed by Equation (1) as

R=R₀*(1+αΔT+β(ΔT)²), (1)

wherein R₀ refers to the resistance at room temperature, ΔT=T−T₀, wherein T₀ equals room temperature, and α and β are coefficients of the wire material comprised by the wire filament, the temperature T can be determined in this fashion. Nevertheless, a calibration procedure is required in order to determine the coefficients α and β. Herein, particular care is needed for finding the resistance R₀ of the lamp at room temperature T₀ which, particularly, influences quality and precision of the calibration procedure. Even small errors with respect to the measurements of the current and the voltage can result in large variations of the temperature T as determined in this fashion. Further, changes of the wire filament, in particular by evaporation of tungsten during the operation of the lamp, may cause systematic errors in the determination of the temperature T of the wire filament in the lamp. Similar considerations are applicable to thermal infrared emitters.

Methods and devices for monitoring radiation emitted by a thermal radiation source which comprise determining an emission temperature of a radiation emitting element by evaluating a spectral radiance of the radiation at at least one wavelength are disclosed in Raytek: “Filament Control—Function Test of the Filament Light Bulb”, Raytek Application Note, 2009, available via http://www.appliedmc.com/content/images/RaytekAN19_Glass_Glass_Filament_RevB.pdf; DE 10 2012 112 412 A1; Far Associates: “Tungsten Filament Emissivity Behavior”, 2006, available via http://pyrometry.com/farassociates_tungstenfilaments.pdf; Vittorio Zanetti: “Temperature of incandescent lamps”, Am. J. Phys. 53(6), 1985, pp. 546-548; Zdenek Navratil et al: “Study of Planck law with a small USB grating spectrometer, Phys. Education, Inst. Phys. Publishing 48(3), 2013, pp. 289-297; Javier E. Hasbun: “Simple experiments and modeling of incandescent lamp spectra”, Georgia Journal of Science 73(2-4), 2015, pp. 160-168; and Lechner W. et al.: “Temperature measurement of filaments above 2500K applying two-wavelength pyrometry”, DATABASE INSPEC [Online], Database accession no. 860213, & TEMPERATURE MEASUREMENT, 1975, pp. 297-305.

Further, Arnaud J. Onnink et al.: “How hot is the wire: Optical, electrical, and combined methods to determine filament temperature”, Thin Solid Films 67(4), 01.03.2019, pp. 22-32, discloses a spectrometer having two detectors; one in the visible and one in the NIR range, wherein the detectors may comprise an InGaAs diode array and a single-channel pyrometer.

Further, Senkov A. G. et al.: “Reduction of methodological errors in determining the temperature of metals by two-color pyrometers”, J. Engineering Physics & Thermophysics 79(4), 2006, pp. 768-772; Madruga F. J. et al.: “Error Estimation in a Fiber-Optic Dual Waveband Ratio Pyrometer”, IEEE Sensors Journal 4(3), 2004, pp. 288-293; Müller B et al.: “Development of a fast fiber-optic two-color pyrometer for the temperature measurement of surfaces with varying emissivities”, Rev. Sc. Instr. 72(8), 2001, pp. 3366-3374; Igor Bonefacic et al.: “Two-color temperature measurement method using BPW34 PIN photodiodes”, Eng. Rev. 35(3), 2015, pp. 259-266; and “Theory and Practice of Radiation Thermometry”, Chapter 13: “Tungsten Ribbon Lamps”, pp. 773-779, 1988 disclose background information with respect to the present invention.

Despite the advantages implied by the above-mentioned methods and devices, there still is a room for improvements with respect to a simple, cost-efficient and, still, reliable method and device for monitoring radiation, in particular of radiation emitted by thermal radiation source, in particular by an incandescent lamp or a thermal infrared emitter, within the visible and the infrared spectral ranges, specifically for determining an emission spectrum of the thermal radiation source which can be used as a background spectrum in a spectroscopic application.

### Problem Addressed by the Invention

Therefore, a problem addressed by the present invention is that of specifying a method and a device for monitoring radiation as well as a computer program product comprising executable instructions for performing the method, which at least substantially avoids the disadvantages of known devices and methods of this type.

In particular, it is desired that the present method and device can monitor radiation which is emitted by a thermal radiation source, in particular by an incandescent lamp or a thermal infrared emitter, within the visible and the infrared spectral ranges, specifically for determining an emission spectrum of the thermal radiation source, in particular for monitoring various operational modes of the thermal radiation source, specifically in a spectroscopic application which covers at least a partition of the visible and the infrared spectral ranges.

More particular, it is desirable to be capable of monitoring the emission of the thermal radiation source in order to maintain the emission in a stable and reproducible manner. Moreover, high reproducibility and device independency are desirable, which would, especially, allow a transferability between different devices in order to improve quality and reliability of recorded data obtained in the spectroscopic application.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used herein, the expressions “have”, “comprise” and “contain” as well as grammatical variations thereof are used in a non-exclusive way. Thus, the expression “A has B” as well as the expression “A comprises B” or “A contains B” may both refer to the fact that, besides B, A contains one or more further components and/or constituents, and to the case in which, besides B, no other components, constituents or elements are present in A.

In a first aspect of the present invention, a method for monitoring radiation emitted by a radiation emitting element of a thermal radiation source is disclosed. The method as disclosed herein comprises the following steps, which may, preferably, be performed in the given order. Further, additional method steps can be provided which are not listed here. Unless explicitly indicated otherwise, any or all of the method steps may, at least partially, be performed in a simultaneous manner. Further, any or all of the method steps might be performed twice or more than twice, such as in a repeated fashion.

The method according to the present invention comprises the following steps:
a) providing a thermal radiation source comprising a radiation emitting element, wherein the radiation emitting element emits radiation to be monitored wherein the radiation emitting element comprises a wire filament of an incandescent lamp or a radiation emitting surface of a thermal infrared emitter;
b) providing at least one radiation sensitive element, wherein the radiation sensitive element is designated for measuring the radiation by the radiation emitting element;
c) measuring a spectral radiance of the radiation emitted by the radiation emitting element at at least two individual wavelengths; and
d) determining an emission temperature of the radiation emitting element by providing a ratio of the measured values of the spectral radiance of the radiation at the at least two individual wavelengths.

According to step a), a thermal radiation source is provided, wherein a radiation emitting element emits radiation to be monitored. As used herein, the term “thermal radiation source” refers to a source which is configured for emitting radiation by a radiation emitting element in a thermal process, especially in at least a partition of the visible and infrared spectral ranges. In particular, the thermal radiation source may be selected from an incandescent lamp or a thermal infrared emitter. As generally used, the terms “incandescent lamp”, “incandescent light bulb” or “incandescent light globe” relate to a device having a volume confined by a bulb, in particular of glass or fused quartz, wherein a wire filament, which may, specifically, comprise tungsten, is located as the radiation emitting element in the volume, preferably filled with inert gas or comprising a vacuum, where it emits the radiation to be monitored. As further used, the term “thermal infrared emitter” refers to a micro-machined thermally emitting device which comprises a radiation emitting surface as the radiation emitting element that emits the radiation to be monitored. By way of example, thermal infrared emitters are available under the name “emirs50” from Axetris AG, Schwarzenbergstrasse 10, CH-6056 Kagiswil, Switzerland, as “thermal infrared emitters” from LASER COMPONENTS GmbH, Werner-von-Siemens-Str. 15 82140 Olching, Germany, or as “infra-red emitters” from Hawkeye Technologies, 181 Research Drive #8, Milford Conn. 06460, United States. However, further types of thermal infrared emitter may also be feasible. Herein, the radiation emitting element, i.e. the wire filament of the incandescent lamp or the radiation emitting surface of the thermal infrared emitter, is designated to be impinged by an electrical current in a fashion that a heating thereof results in emitting a considerable amount of electromagnetic radiation. As used herein, the term “radiation” refers to an emission of photons by the heated radiation emitting element, in particular the heated wire filament or the radiation emitting surface, in a manner that wavelengths of the emitted photons cover a considerably wide spectral range, specifically the visible spectral range and, in particular, the near infrared (NIR) spectral range. As generally used, the visible spectral range covers wavelengths of 380 nm to 780 nm while the NIR spectral range covers wavelengths of 780 nm to 1400 nm.

As further used herein, the term “monitoring” refers to a process of deriving desired information from continuously acquired data without user interaction, wherein the term “measuring” relates to a process of continuously acquiring the data without user interaction. For this purpose, a plurality of measurement signals are generated and evaluated, wherefrom the desired information is determined. Herein, the plurality of measurement signals may be recorded and/or evaluated within fixed or variable time intervals or, alternatively or in addition, at an occurrence of at least one prespecified event. In particular, the method according to the present invention may, especially, be designated for continuously determining parameters related to operational modes of the thermal radiation source, specifically of the incandescent lamp or the thermal infrared emitter, specifically in a spectroscopic application in which the thermal radiation source may, preferably, be used as illumination source.

According to step b), at least one radiation sensitive element is provided, wherein the radiation sensitive element is designated for measuring the radiation. As used herein, the “radiation sensitive element” is, generally, a device which is designated for generating at least one sensor signal in a manner dependent on a reception of radiation by the radiation sensitive element or a part thereof. As an example, the sensor signal may be or may comprise a digital and/or an analog signal. As an example, the sensor signal may be or may comprise a voltage signal and/or a current signal. Additionally or alternatively, the sensor signal may be or may comprise digital data. The sensor signal may comprise a single signal value and/or a series of signal values. The sensor signal may further comprise an arbitrary signal which is derived by combining two or more individual signals, such as by averaging two or more signals and/or by forming a quotient of two or more signals.

Herein, the radiation sensitive element may, preferably be selected from a radiation sensor having a sensor region. As used herein, the “sensor region” is considered as a portion of the radiation sensor which is designated for receiving the radiation generated by the radiation emitting element in a manner that a generation of the at least one sensor signal may be triggered, wherein the generation of the sensor signal may be governed by a defined relationship between the sensor signal and the manner of the illumination of the sensor region. In general, the sensor region may be a uniform sensor region or, as an alternative, comprise a radiation sensitive array which may be partitioned into a plurality of radiation sensitive pixels. In a particular embodiment, the radiation sensitive element may be comprised by an electronic device, in particular an electronic communication unit, such as a smartphone or a tablet. By way of example, a smartphone may comprise one or more radiation sensitive elements which are, typically, used as camera and/or for display control. In an alternative embodiment, the radiation sensitive array may be provided by a spectrometer pixel array which is being used in a spectrometer device, wherein at least two radiation sensitive pixels of the spectrometer pixel array may constitute the sensor region. In this particular embodiment, pixels that are located at an edge of the spectrometer pixel array may, preferably, be used as the sensor region, in particular, in order to obtain a maximum spectral distance between the pixels used for this purpose. However, further arrangements may also be feasible.

Thus, the sensor signal may be generated in a manner dependent on an illumination of the sensor region by the radiation, wherein the sensor signal may be an arbitrary signal being indicative of a spectral radiance of the incident radiation illuminating the sensor region. For a purpose of generating the sensor signal upon illumination, the sensor region comprises a radiation sensitive material, wherein the radiation sensitive material may, preferably be selected from silicon, in particular for incident wavelengths up to 1 μm. For incident wavelengths above 1 μm, the radiation sensitive material may, alternatively, be selected from indium gallium arsenide (InGaAs), in particular for incident wavelengths up to 2.6 μm; indium arsenide (InAs), in particular for incident wavelengths up to 3.1 μm; lead sulfide (PbS), in particular for incident wavelengths up to 3.5 μm; lead selenide (PbSe), in particular for incident wavelengths up to 5 μm; indium antimonide (InSb), in particular for incident wavelengths up to 5.5 μm; and mercury cadmium telluride (MCT, HgCdTe), in particular for incident wavelengths up 16 μm. However, further kinds of materials may also be conceivable.

According to step c), a spectral radiance of the radiation which is emitted by the radiation emitting element of the thermal radiation source is measured at at least two individual wavelengths. As used herein, the term “spectral radiance” refers to a radiant flux emitted by the radiation emitting element comprised by the thermal radiation source per unit solid angle, per unit area, and per wavelength. As a result, the spectral radiance indicates how much of a power emitted by the radiation emitting element can actually be received at a particular wavelength by the radiation sensitive element looking at the radiation emitting element from a specified angle of view. Therefore, the spectral radiance can also be denoted by the term “intensity” of the radiant flux emitted by the radiation emitting element.

Further, the surface of the radiation emitting element as any other body spontaneously and continuously emits electromagnetic radiation, wherein the spectral radiance of the radiation emitting element relates to an amount of energy which is emitted by the radiation emitting element at different radiation wavelengths. In accordance with Planck's law, the spectral radiance B_{λ} of the radiation emitting element for the wavelength λ at an emission temperature T in K of the radiation emitting element is defined by Equation (2) as

$${B}_{λ} ( λ , T ) = \frac{2 h {c}^{2}}{{λ}^{5}} \cdot \frac{1}{{e}^{\frac{h c}{λ {k}_{B} T}} - 1} , \qquad ( 2 )$$

wherein h is Planck's constant, c the speed of light, and k_{B} the Boltzmann constant. Thus, Planck's law provides a relationship between the spectral radiance B_{λ} of the radiation which is emitted by the radiation emitting element of the thermal radiation source and the emission temperature of the radiation emitting element.

Although Planck's law is based on the emission of a perfectly black body which, strictly speaking, does not exist in reality, the emission of a black surface as, for example, comprised by the radiation emitting element of the thermal radiation source, in particular by the wire filament of the incandescent lamp or by the radiation emitting surface in the thermal infrared emitter, can be accurately approximated hereby in practice. As a result of Planck's law, the spectral radiance B_{A} of the radiation emitting element depends only on the wavelength λ of the radiation and the temperature T of the radiation emitting element. With increasing wavelength, a spectral radiance curve of the radiation emitting element according to Equation (2) exhibits, as generally known, a rising edge, followed by a peak and, subsequently, by a falling edge.

In a particular embodiment, the spectral radiance of the radiation can be measured within at least one selected range of wavelengths [λ₁, λ₂] which may be provided by a specific thermal radiation source which is designated for emitting radiation within the least one selected range of wavelengths [λ₁,λ₂]. For this purpose, at least one filter, specifically an absorption filter, such as a band pass filter, or, as an alternative, a photonic crystal, may be used. By way of example, a band pass filter may be placed in front of the wire filament of the incandescent lamp. Alternatively, a photonic crystal may be placed in front of the radiation emitting surface of the thermal infrared emitter. As generally used, the term “photonic crystal” refers to a periodic optical nanostructure which is designed for affecting a propagation of the photons within the nanostructure, in particular in a fashion that at least one disallowed energy band may be generated, wherein the propagation of the photons is inhibited. As a result thereof, the photonic crystal can act as filter for wavelengths within the disallowed energy bands. However, further kinds of filters which could be used for this purpose may also be conceivable.

Thus, according to step d), the temperature T in K which can be considered as the emission temperature of the radiation emitting element comprised by the thermal radiation source can be determined by evaluating the spectral radiance B_{λ} of the radiation emitted by the radiation emitting element at the wavelength λ. Consequently, a single intensity measurement at a given wavelength using a calibrated sensor is, in principle, already sufficient for determining the temperature of the radiation emitting element.

Therefore, in an embodiment in which the spectral radiance of the radiation as emitted by the radiation emitting element may be measured at a single wavelength, the emission temperature of the radiation emitting element may be determined by comparing a measured value of the spectral radiance for the single wavelength with a known value of the spectral radiance for the single wavelength. Herein, the known value of the spectral radiance may, in particular, be obtained in a calibration of the radiation sensitive element, wherein the calibration may, preferably, be performed prior to performing the measurement. However, a difference sequence may also be feasible. For this purpose, a known thermal radiation source, in particular a known incandescent lamp or a known thermal infrared emitter, having a known emission temperature of the radiation emitting element, in particular of the wire filament in the incandescent lamp or of the radiation emitting surface, respectively, can be used for the calibration of the radiation sensitive element.

In a particular embodiment, the measuring of the spectral radiance of the radiation which is emitted by the radiation emitting element may be performed in a same controlled environment in which the calibration of the radiation sensitive element is performed, specifically in which a preceding calibration of the radiation sensitive element has been performed. Preferably, the calibration is performed in the controlled environment under constant ambient conditions in order to avoid calibration errors as far as possible. Further, the measurement of the spectral radiance of the radiation emitted by the radiation emitting element may be performed in the same controlled environment which may, in particular, include but not be limited to detector conditions such as a temperature of the detector in order to avoid a drift from calibration data and, consequently, a measurement error. By way of example, a blackening of the incandescent lamp due to an evaporation of metal from the wire filament onto an interior surface of the bulb may result in errors in the determination of the emission temperature of the wire filament. However, further reasons for a possible drift of the calibration data may also be conceivable.

According to the present invention, the spectral radiance of the radiation which is emitted by the radiation emitting element of the thermal radiation source is measured at two or more individual wavelengths, preferably at two individual wavelengths, which differ from each other. As indicated above, the two individual wavelengths may be selected from at least one selected range of wavelengths [λ₁, λ₂]. In a particularly preferred embodiment, a first wavelength λ₁ at which the spectral radiance may be measured can, thus, be selected from the rising edge of the spectral radiance curve, preferably within the visual spectral range, in particular from a wavelength of 500 nm to 600 nm, whereas a second wavelength λ₂ at which the spectral radiance may, also, be measured can be selected from the falling edge of the spectral radiance curve, preferably within the near infrared spectral range, in particular from a wavelength of 800 nm to 1000 nm, wherein, in general, a larger difference between the first wavelength and the second wavelength may be preferred since it may contribute to increasing an accuracy of the determination of the emission temperature of the radiation emitting element. Herein, an increase in gradient of the curve may result in an increased accuracy of temperature determination. Further, stable and easily accessible silicon detectors can be employed for both selected spectral ranges. However, further wavelengths at which the spectral radiance can be measured may also be feasible.

Measuring the spectral radiance of the radiation of the radiation emitting element at two or more individual wavelengths in order to determine the temperature of the radiation emitting element exhibits various advantages. While in a practical setup various external impacts, in particular changes of the resistance of the wire filament or metal evaporation from the wire filament, may deteriorate a measurement when using a single wavelength, the determination of the temperature of the wire filament has been demonstrated to be more stable when the measurement is performed at at least two different wavelengths.

Thus, the emission temperature of the radiation emitting element of the thermal radiation source can, preferably, be determined by comparing measured values of the spectral radiance for the two or more of the individual wavelengths λ₁, λ₂, . . . at which the spectral radiance has been measured. In order to further reduce external impacts, the emission temperature of the radiation emitting element of the thermal radiation source can be determined by providing a ratio of the measured values of the spectral radiance for two of the individual wavelengths λ₁, λ₂, especially a quotient of the measured values of the spectral radiance for the two individual wavelengths λ₁, λ₂. Using Equation (2) above for the two different wavelengths λ₁, λ₂, a quotient can be determined according to Equation (3) as follows:

$$\frac{{B}_{λ} ( {λ}_{1} , T )}{{B}_{λ} ( {λ}_{2} , T )} = \frac{{λ}_{2}^{5}}{{λ}_{1}^{5}} \cdot \frac{{e}^{\frac{h c}{{λ}_{2} {k}_{B} T}} - 1}{{e}^{\frac{h c}{{λ}_{1} {k}_{B} T}} - 1} . \qquad ( 3 )$$

As a result of a quotient generation, the quotient

$$\frac{{B}_{λ} ( {λ}_{1} , T )}{{B}_{λ} ( {λ}_{2} , T )}$$

depends only on the two different wavelengths λ₁, λ₂ of the radiation and the emission temperature T of the radiation emitting element. Consequently, any efforts with respect to the calibration can, significantly, be reduced since most external impacts cancel as a result of the quotient.

In particular embodiment, a relative spectral sensitivity of the radiation sensitive elements at the selected wavelengths can, further, be taken into account when evaluating the spectral radiance of the radiation at the respective wavelength, thereby further increasing the accuracy of the measurements. For this purpose, the spectral sensitivities of the radiation sensitive elements may be incorporated into Equation (3), preferably by using a summation or a weighted integral or over two of the individual wavelengths λ₁, λ₂, or by performing calibration measurements at the respective wavelengths λ₁, λ₂.

Still, the function according to Equation (3) is a transcendent function which cannot be inverted analytically. However, the ratio of the measured values of the spectral radiance for the two of the individual wavelengths λ₁, λ₂ as a function of T of the radiation emitting element can be approximated by using an algebraic function, in particular for particular values of the individual wavelengths λ₁, λ₂ and a particular temperature range which comprises temperatures being applicable for the radiation emitting element as used in a thermal radiation source. Preferably, the algebraic function can be selected from a polynomial function, wherein the polynomial function may, especially, be a polynomial function of fourth order or below. Further, it can be demonstrated as below that the polynomial function can even be selected from a polynomial function of second order within a selected temperature range, in particular within the temperature range from 1000 K to 4000 K.

In a further aspect, the present invention refers to computer program product which comprises executable instructions for performing the method for monitoring radiation emitted by a radiation emitting element of a thermal radiation source as described elsewhere herein.

In particular, the computer program product comprising executable instructions may fully or partially be integrated into an electronic device, in particular an electronic communication unit, specifically a smartphone or a tablet, or a spectrometer device. Herein, it may be capable of performing the method in a relationship with one or more radiation sensitive elements which are already comprised by the smartphone for use as a camera and/or for display control and a data processing device which is already also comprised by the smartphone for various purposes. By way of example, the method may be performed as an application, also denoted as “app”, on the smartphone for this purpose. Alternatively, the computer program product may be capable of performing the method in a relationship with the spectrometer pixel array and a data processing device both already comprised by the spectrometer device. In addition, further kinds of electronic device may also be conceivable.

In a further aspect of the present invention, a device for monitoring radiation emitted by a radiation emitting element of a thermal radiation source, wherein the radiation emitting element comprises a wire filament of an incandescent lamp or a radiation emitting surface of a thermal infrared emitter, is disclosed. According to the present invention, the device comprises:
at least one radiation sensitive element, wherein the radiation sensitive element is designated for measuring radiation which is emitted by the radiation emitting element of the thermal radiation source at at least two individual wavelengths; and
an evaluation device, wherein the evaluation device is designated for determining an emission temperature of the radiation emitting element of the thermal radiation source by providing a ratio of the measured values of the spectral radiance of the radiation at the at least two individual wavelengths, wherein the ratio of the measured values of the spectral radiance for the two of the individual wavelengths as a function of temperature is approximated by using a polynomial function of second order within a temperature range from 1000 K to 4000 K.

Herein, the listed components may be separate components. Alternatively, two or more of the components may be integrated into one component. Further, the evaluation device may be provided as a separate evaluation device independent from the radiation sensitive element, but may, preferably, be connected to the radiation sensitive element in order to receive the sensor signal. Alternatively, the at least one evaluation device may fully or partially be integrated into the radiation sensitive element or the evaluation device and the radiation sensitive element may jointly be integrated into an electronic device, in particular an electronic communication unit, such as a smartphone or a tablet. However, further kinds of electronic device may also be conceivable. As a further alternative described below in more detail, the device may be integrated into a spectrometer device.

As used herein, the term “evaluation device” generally refers to an arbitrary device which is designed for generating items of information based on measured data. More particular, the evaluation device according to the present invention is designated for determining the emission temperature T of the radiation emitting element by evaluating measured data which are in relationship with the spectral radiance of the radiation of the radiation emitting element at one or more wavelengths, wherein the measured data are acquired by the at least one radiation sensitive element and transferred to the evaluation device. For this purpose, the evaluation device may be or comprise one or more integrated circuits, such as one or more application-specific integrated circuits (ASICs), and/or one or more digital signal processors (DSPs), and/or one or more field programmable gate arrays (FPGAs), and/or one or more data processing devices, such as one or more computers, preferably one or more microcomputers and/or microcontrollers. Additional components may be comprised, such as one or more preprocessing devices and/or data acquisition devices, such as one or more devices for receiving and/or preprocessing of the sensor signals, such as one or more AD-converters and/or one or more filters. Further, the evaluation device may comprise one or more data storage devices. Further, as outlined above, the evaluation device may comprise one or more interfaces, such as one or more wireless interfaces and/or one or more wire-bound interfaces. Further, as outlined above, a data processing device as already comprised by a smartphone for various purposes may be used as the evaluation device. As further outlined above, a data processing device as already comprised by a spectrometer device could also be used as the evaluation device.

In a further aspect of the present invention, a spectrometer device is disclosed. According to the present invention, the spectrometer device comprises:
an illumination source, wherein the illumination source is designated for illuminating an object in order to record a spectrum of the object;
a spectrometer pixel array comprising a plurality of radiation sensitive pixels, wherein the spectrometer pixel array is designated for recording the spectrum of the object by generating at least one pixel sensor signal;
a spectrometer evaluation device, wherein the spectrometer evaluation device is designated for determining the spectrum of the object from the at least one pixel sensor signal,
   wherein the illumination source comprises a thermal radiation source having a radiation emitting element for emitting radiation for illuminating the object, wherein the radiation emitting element comprises a wire filament of an incandescent lamp or a radiation emitting surface of a thermal infrared emitter,
   wherein at least one of the radiation sensitive pixels constitutes at least one radiation sensitive element, wherein the radiation sensitive element is designated for measuring radiation which is emitted by the radiation emitting element of the thermal radiation source at at least two individual wavelengths,
   wherein the spectrometer evaluation device is further designated for determining an emission temperature of the radiation emitting element of the thermal radiation source by providing a ratio of the measured values of the spectral radiance of the radiation at the at least two individual wavelengths, wherein the ratio of the measured values of the spectral radiance for the two of the individual wavelengths as a function of temperature is approximated by using a polynomial function of second order within a temperature range from 1000 K to 4000 K, and for adjusting the spectrum of the object by using the emission temperature of the radiation emitting element.

As a consequence thereof, the device according to the present invention, which can also be denoted as a “radiation monitoring device”, may, in this preferred embodiment, be comprised by the spectrometer device in an integrated fashion. However, as an alternative, the radiation monitoring device may, as described elsewhere herein, be provided as a separate device which may, preferably, be attachable to an arbitrary spectrometer device for achieving a similar or the same function. Irrespective of the embodiment of the radiation monitoring device, the radiation monitoring device may, in particular, be used for monitoring of a pre-heating phase of the spectrometer device; for monitoring of a stable operation of the thermal radiation source, thus allowing high-speed measurements and short integration times with the spectrometer device; for a variable color temperature of the thermal radiation source for being used in the calibration of the spectrometer device; and for monitoring of a deviation of the thermal radiation source, such as a blackening of the lamp in the spectrometer device, specifically due to an evaporation of tungsten metal from the wire filament onto the interior surface of the bulb. However, further uses of the device may still be conceivable.

For further details with respect to the radiation monitoring device, the spectrometer device, or the computer program product according to the present invention, reference may be made to the description of the method for monitoring radiation emitted by a radiation emitting element of a thermal radiation source as provided elsewhere herein.

The above-described method and device for monitoring radiation emitted by a radiation emitting element of a thermal radiation source and the proposed uses of the device have considerable advantages over the prior art. In particular, the present method and device can monitor radiation emitted by the radiation emitting element as comprised by the thermal radiation source within the visible and the infrared spectral ranges, specifically an emission spectrum of the thermal radiation source or various operational modes of the thermal radiation source, in order to maintain the emission of the radiation emitting element in a stable and reproducible manner, thereby achieving high reproducibility and device independency. As a result thereof, transferability between different devices is feasible, especially, in order to improve the quality and the reliability of the recorded data which are obtained in the spectroscopic application.

Summarizing, in the context of the present invention, the following embodiments are regarded as particularly preferred:

Embodiment 1: A method for monitoring radiation emitted by a radiation emitting element of a thermal radiation source, wherein the method comprises the following steps:
a) providing a thermal radiation source comprising a radiation emitting element, wherein the radiation emitting element emits radiation to be monitored;
b) providing at least one radiation sensitive element, wherein the radiation sensitive element is designated for measuring the radiation by the radiation emitting element;
c) measuring a spectral radiance of the radiation emitted by the radiation emitting element at at least one wavelength; and
d) determining an emission temperature of the radiation emitting element by evaluating the spectral radiance of the radiation at the at least one wavelength.

Embodiment 2: The method according to the preceding Embodiment, wherein the spectral radiance of the radiation at the at least one wavelength is evaluated by using Planck's law.

Embodiment 3: The method according to the preceding Embodiment, wherein Planck's law provides a relationship between the spectral radiance of the radiation emitted by the radiation emitting element and the emission temperature of the radiation emitting element.

Embodiment 4: The method according to any one of the preceding Embodiments, wherein the spectral radiance of the radiation is measured within at least one selected range of wavelengths [λ₁, λ₂]

Embodiment 5: The method according to any one of the preceding Embodiments, wherein the spectral radiance of the radiation emitted by the radiation emitting element is measured at at least two individual wavelengths.

Embodiment 6: The method according to the preceding Embodiment, wherein a relative spectral sensitivity of the radiation sensitive element at the at least two individual wavelengths is further considered in evaluating the spectral radiance of the radiation at the at least two individual wavelengths.

Embodiment 7: The method according to any one of the two preceding Embodiments, wherein the emission temperature of the radiation emitting element is determined by comparing measured values of the spectral radiance for at least two of the individual wavelengths.

Embodiment 8: The method according to any one of the three preceding Embodiments, wherein the emission temperature of the radiation emitting element is determined by providing a ratio of the measured values of the spectral radiance for two of the individual wavelengths.

Embodiment 9: The method according to the preceding Embodiment, wherein the ratio of the measured values of the spectral radiance for two of the individual wavelengths is a quotient of the measured values of the spectral radiance for the two individual wavelengths.

Embodiment 10: The method according to any one of the two preceding Embodiments, wherein the ratio of the measured values of the spectral radiance for the two of the individual wavelengths as a function of temperature is approximated by using an algebraic function.

Embodiment 11: The method according to the preceding Embodiment, wherein the algebraic function is selected from a polynomial function.

Embodiment 12: The method according to the preceding Embodiment, wherein the polynomial function is a polynomial function of fourth order or below.

Embodiment 13: The method according to the preceding Embodiment, wherein the polynomial function is a polynomial function of second order within a selected temperature range.

Embodiment 14: The method according to the preceding Embodiment, wherein the temperature range is selected from 1000 K to 4000 K.

Embodiment 15: The method according to any one of the ten preceding Embodiments, wherein a first wavelength at which the spectral radiance is measured is selected from the visual spectral range.

Embodiment 16: The method according to the preceding Embodiment, wherein the first wavelength is selected from a wavelength in the rising edge of the spectral radiance curve, preferably within the visual spectral range, in particular from 500 nm to 600 nm.

Embodiment 17: The method according to any one of the two preceding Embodiments, wherein a second wavelength at which the spectral radiance is measured is selected from the near infrared spectral range.

Embodiment 18: The method according to the preceding Embodiment, wherein the second wavelength is selected from a wavelength in the falling edge of the spectral radiance curve, preferably within the near infrared spectral range, in particular from 800 nm to 1000 nm.

Embodiment 19: The method according to any one of the preceding Embodiments, wherein the spectral radiance of the radiation emitted by the radiation emitting element is measured at a single wavelength.

Embodiment 20: The method according to the preceding Embodiment, wherein the emission temperature of the radiation emitting element is determined by comparing a measured value of the spectral radiance for the single wavelength with a known value of the spectral radiance for the single wavelength.

Embodiment 21: The method according to the preceding Embodiment, wherein the known value of the spectral radiance is obtained in a calibration of the radiation sensitive element.

Embodiment 22: The method according to the preceding Embodiment, wherein a known thermal radiation source having a known emission temperature of the radiation emitting element is used for the calibration of the radiation sensitive element.

Embodiment 23: The method according to any one of the two preceding Embodiments, wherein the measuring of the spectral radiance of the radiation emitted by the radiation emitting element is performed in a same controlled environment in which the calibration of the radiation sensitive element is performed.

Embodiment 24: The method according to any one of the preceding Embodiments, wherein the thermal radiation source is selected from at least one of an incandescent lamp or a thermal infrared emitter.

Embodiment 25: The method according to the preceding Embodiment, wherein the radiation emitting element is selected from at least one of a wire filament of the incandescent lamp or a radiation emitting surface of the thermal infrared emitter.

Embodiment 26: A computer program product which comprises executable instructions for performing the method according to any one of the preceding Embodiments.

Embodiment 27: A device for monitoring radiation emitted by a radiation emitting element of a thermal radiation source, wherein the device comprises:
at least one radiation sensitive element, wherein the radiation sensitive element is designated for measuring radiation which is emitted by the radiation emitting element of the thermal radiation source at at least one wavelength; and
an evaluation device, wherein the evaluation device is designated for determining an emission temperature of the radiation emitting element of the thermal radiation source by evaluating the spectral radiance of the radiation at the at least one wavelength.

Embodiment 28: The device according to the preceding Embodiment, wherein the evaluation device is designated for evaluating the spectral radiance of the radiation at the at least one wavelength by using Planck's law.

Embodiment 29: The device according to the preceding Embodiment, wherein Planck's law provides a relationship between the spectral radiance of the radiation emitted by the radiation emitting element and the emission temperature of the radiation emitting element.

Embodiment 30: The device according to any one of the preceding Embodiments related to the device, wherein the evaluation device is further designated for considering a relative spectral sensitivity of the radiation sensitive element at the at least two individual wavelengths in evaluating the spectral radiance of the radiation at the at least two individual wavelengths.

Embodiment 31: The device according to any one of the preceding Embodiments related to the device, wherein the radiation sensitive element comprises a radiation sensor having at least one sensor region.

Embodiment 32: The device according to the preceding Embodiment, wherein the sensor region comprises a radiation sensitive material.

Embodiment 33: The device according to the preceding Embodiment, wherein the radiation sensitive material is selected from silicon, indium gallium arsenide (InGaAs), indium arsenide (InAs), lead sulfide (PbS), lead selenide (PbSe), indium antimonide (InSb), and mercury cadmium telluride (MCT, HgCdTe).

Embodiment 34: The device according to any one of the three preceding Embodiments related to the device, wherein the sensor region is a uniform sensor region.

Embodiment 35: The device according to the preceding Embodiment, wherein the sensor region is provided by an electronic device.

Embodiment 36: The device according to the preceding Embodiment, wherein the sensor region is provided by an electronic communication unit.

Embodiment 37: The device according to the preceding Embodiment, wherein the sensor region is provided by a smartphone or a tablet.

Embodiment 38: The device according to any one of the five preceding Embodiments related to the device, wherein the sensor region comprises a radiation sensitive array being partitioned into a plurality of radiation sensitive pixels.

Embodiment 39: The device according to the preceding Embodiment, wherein the radiation sensitive array is provided by a spectrometer pixel array, wherein at least two radiation sensitive pixels of the spectrometer pixel array constitute the sensor region.

Embodiment 40: The device according to the preceding Embodiment, wherein the at least two pixels are located at an edge of the spectrometer pixel array.

Embodiment 41: The device according to any one of the preceding Embodiments related to the device, wherein the radiation sensitive element is designated for measuring radiation by generating a sensor signal by measuring an electrical resistance or a conductivity of at least a part of the sensor region.

Embodiment 42: The device according to the preceding Embodiment, wherein the radiation sensitive element is designated to generate the sensor signal by performing at least one current-voltage measurement and/or at least one voltage-current-measurement.

Embodiment 43: The device according to any one of the preceding Embodiments related to the device, wherein the thermal radiation source is selected from at least one of an incandescent lamp or a thermal infrared emitter.

Embodiment 44: The device according to the preceding Embodiment, wherein the radiation emitting element is selected from at least one of a wire filament of the incandescent lamp or a radiation emitting surface of the thermal infrared emitter.

Embodiment 45: The device according to any one of the preceding Embodiments related to the device, further comprising at least one filter for selecting at least one range of wavelengths [λ₁, λ₂] for measuring the spectral radiance of the radiation.

Embodiment 46: The device according to the preceding Embodiment, wherein the filter is selected from at least one of an absorption filter, in particular a band pass filter; or a photonic crystal.

Embodiment 47: A spectrometer device comprising:
an illumination source, wherein the illumination source is designated for illuminating an object in order to record a spectrum of the object;
a spectrometer pixel array comprising a plurality of radiation sensitive pixels, wherein the spectrometer pixel array is designated for recording the spectrum of the object by generating at least one pixel sensor signal;
a spectrometer evaluation device, wherein the spectrometer evaluation device is designated for determining the spectrum of the object from the at least one pixel sensor signal,
   wherein the illumination source comprises a thermal radiation source having a radiation emitting element for emitting radiation for illuminating the object,
   wherein at least one of the radiation sensitive pixels constitutes at least one radiation sensitive element, wherein the radiation sensitive element is designated for measuring radiation which is emitted by the radiation emitting element at at least one wavelength,
   wherein the spectrometer evaluation device is further designated for determining an emission temperature of the radiation emitting element by evaluating the spectral radiance of the radiation at the at least one wavelength, and for adjusting the spectrum of the object by using the emission temperature of the radiation emitting element.

Embodiment 48: The spectrometer device according to the preceding Embodiment, wherein at least two radiation sensitive pixels constitute the sensor region.

Embodiment 49: The spectrometer device according to the preceding Embodiment, wherein the at least two pixels are located at an edge of the spectrometer pixel array.

Embodiment 50: The spectrometer device according to any one of the preceding Embodiments related to the spectrometer device, wherein the thermal radiation source is selected from at least one of an incandescent lamp or a thermal infrared emitter.

Embodiment 51: The spectrometer device according to the preceding Embodiment, wherein the radiation emitting element is selected from at least one of a wire filament of the incandescent lamp or a radiation emitting surface of the thermal infrared emitter.

### BRIEF DESCRIPTION OF THE FIGURES

Further optional details and features of the invention are evident from the description of preferred exemplary embodiments which follows in conjunction with the dependent claims. In this context, the particular features may be implemented alone or with features in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 illustrates a preferred exemplary embodiment of a device for monitoring radiation emitted by a radiation emitting element of a thermal radiation source according to the present invention;

FIG. 2 illustrates a further preferred exemplary embodiment of the device for monitoring the radiation emitted by the radiation emitting element of the thermal radiation source according to the present invention;

FIG. 3 illustrates a diagram indicating a preferred exemplary embodiment of a method for monitoring the radiation emitted by the radiation emitting element of the thermal radiation source according to the present invention; and

FIG. 4 illustrates experimental results for a quotient of two values for a spectral radiance measured for two different wavelengths versus an emission temperature of the radiation emitting element.

### EXEMPLARY EMBODIMENTS

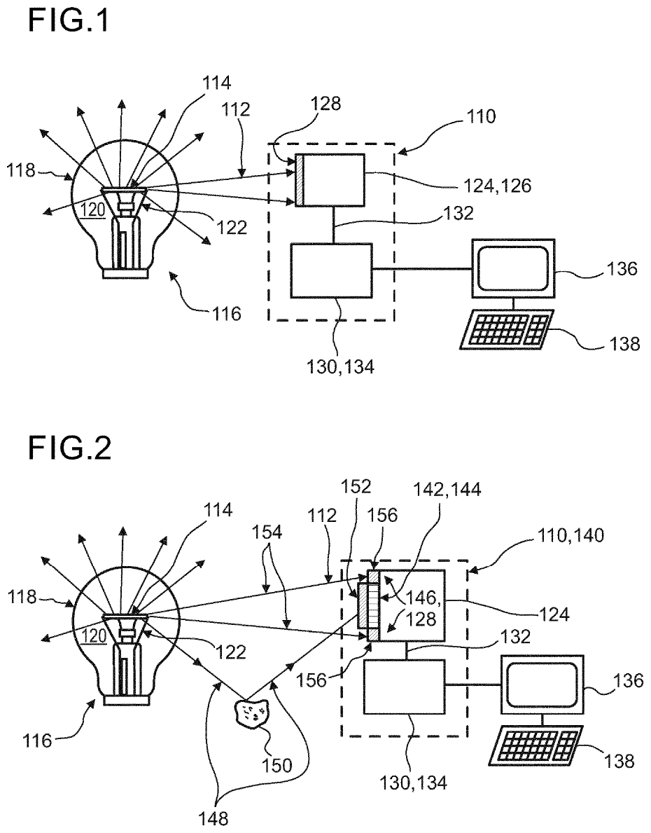

FIG. 1 illustrates, in a highly schematic fashion, an exemplary embodiment of device 110 for monitoring radiation 112 emitted by a radiation emitting element of a thermal radiation source according to the present invention. Without limiting the scope of the present invention, a wire filament 114 of an incandescent lamp 116 is used in the following examples as the radiation emitting element, wherein the incandescent lamp 116 is the selected as the thermal radiation source for this purpose. As an alternative, other kinds of thermal radiation sources, especially a thermal infrared emitter as described above in more detail, may also be used as the thermal radiation source in a similar fashion within the exemplary embodiments of FIGS. 1 to 4.

As schematically depicted in FIG. 1, the incandescent lamp 116 comprises a bulb 118, in particular of glass or fused quartz, wherein the wire filament 114, which may, specifically, comprise tungsten, is located in a volume 120, preferably filled with inert gas or comprising a vacuum, carried by a carrier 122. For a purpose of the generating the desired radiation 112, the wire filament 114 is impinged by an electrical current in a fashion that a heating of the wire filament 114 results in an emission of photons over a considerably wide spectral range, specifically the visible spectral range and, in particular, the near infrared (NIR) spectral range. As generally used, the visible spectral range covers wavelengths of 380 nm to 780 nm while the NIR spectral range covers wavelengths of 780 nm to 1400 nm.

As further illustrated in FIG. 1, the device 110 according to the present invention comprises a radiation sensitive element 124 which is designated for measuring the radiation 112 that is emitted by the wire filament 114 of the incandescent lamp 116 at one or more wavelengths. In the particular embodiment of FIG. 1, the radiation sensitive element 124 is a radiation sensor 126 which comprises a uniform sensor region 128, wherein the sensor region 128 is designated for receiving the illumination of the radiation sensor 126 by the radiation 112 being generated by the wire filament 114 in a manner that a generation of at least one sensor signal may be triggered. Herein, the generation of the sensor signal may be governed by a defined relationship between the sensor signal and the manner of the illumination of the sensor region 128. Herein, the sensor region 128 may have a size of 10 mm×10 mm or less, preferred of 5 mm×5 mm or less, more preferred of 2 mm×2 mm or less.

For a purpose of generating the at least one sensor signal upon illumination, the sensor region 128 comprises a radiation sensitive material which may, preferably be selected from silicon, in particular for incident wavelengths up to 1 μm. For incident wavelengths above 1 μm, the radiation sensitive material may, alternatively, be selected from indium gallium arsenide (InGaAs), in particular for incident wavelengths up to 2.6 μm; indium arsenide (InAs), in particular for incident wavelengths up to 3.1 μm; lead sulfide (PbS), in particular for incident wavelengths up to 3.5 μm; lead selenide (PbSe), in particular for incident wavelengths up to 5 μm; indium antimonide (InSb), in particular for incident wavelengths up to 5.5 μm; and mercury cadmium telluride (MCT, HgCdTe), in particular for incident wavelengths up 16 μm. However, further kinds of materials may also be conceivable.

As described above and below in more detail, the radiation 112 being generated by the wire filament 114 is, preferably, measured at two different wavelengths. For this purpose, the radiation sensitive element 124 as depicted in FIG. 1 is, particularly, selected to be sensitive for the different wavelengths. As an alternative, the radiation sensor 126 may comprise two or more individual uniform sensor regions 128, wherein each of the individual uniform sensor regions 128 may be sensitive to a particular wavelength. As a preferred example, the individual sensor regions 128 may exhibit a high spectral sensitivity between 500 nm and 600 nm, such as around 550 nm, and between 800 nm and 1000 nm, such as around 900 nm, respectively. Herein, a differing spectral sensitivity of the radiation sensitive element 124 at the two different wavelengths can, preferably, be taken into account when evaluating the radiation 112 being measured by the sensor region 128 at the two different wavelengths.

As further illustrated in FIG. 1, the device 110 according to the present invention comprises an evaluation device 130 which is designated for determining an emission temperature T of the wire filament 114 of the incandescent lamp 116 by evaluating a spectral radiance of the radiation 112 at the one or, preferably, more selected wavelengths. For this purpose, the at least one sensor signal as generated by the radiation sensitive element 124 is transferred to the evaluation device 130 by an interface 132, such as a wireless interfaces and/or a wire-bound interface. Further, the evaluation device 130 may comprise a processing device 134, such as a computer, preferably a microcomputer or a microcontroller, which may, be designated for performing the method according to the present invention, in particular by generating a computer program product which comprises executable instructions for performing the method. Further, the evaluation device 130 may be connected to a monitor 136 and/or a keyboard 138 which may, preferably, be located outside the device 110. However, other embodiments of the evaluation device 130 may also be conceivable.

In a particular embodiment, the radiation sensitive element 124 and the evaluation device 130 as well as the monitor 136 and the tablet 138 may be comprised by an electronic device (not depicted here), in particular an electronic communication unit, such as a smartphone or a tablet. Herein, the smartphone may be capable of performing the method according to the present invention by using one or more radiation sensitive elements which are already comprised by the smartphone for a use of a camera and/or for display control and by using a data processing device which is already also comprised by the smartphone for various purposes as well as by using the display of the smartphone as monitor and keyboard. In this respect, the method may be performed as an application, also denoted by the abbreviation of “app”, on the smartphone for the purposes of the present invention.

FIG. 2 illustrates, in a highly schematic fashion, a further preferred exemplary embodiment of the device 110 according to the present invention. In this embodiment, a spectrometer device 140 comprises the device 110 of the present invention in an integrated fashion, wherein the radiation sensitive element 124 may comprise a radiation sensitive array 142 being provided by a spectrometer pixel array 144 which is already being used in the spectrometer device 140 for spectroscopic purposes. Herein, two or more radiation sensitive pixels 146 of the spectrometer pixel array 144 constitute the sensor region 128. For this purpose, in a first beam path 148, the radiation 112 as generated by the wire filament 114 is guided towards an object 150 from where it is reflected to a diffractive device 152 located, apart from the radiation sensitive pixels 146, in front of the spectrometer pixel array 144 while, in a second beam path 154, the radiation 112 as generated by the wire filament 114 is guided directly towards radiation sensitive pixels 146 that constitute the sensor region 128. As schematically depicted in FIG. 2, the radiation sensitive pixels 146 which are located at an edge 156 of the spectrometer pixel array 144 may be preferred for being used as the sensor region 128 since they allow obtaining a maximum spectral distance. However, other kinds of arrangements may also be feasible.

As further depicted in FIG. 2 for this embodiment, the evaluation device 130 as well as the monitor 136 and the tablet 138 may also be comprised by the spectrometer device 140. Herein, a data processing device as already comprised by the spectrometer device 140 may, preferably, be designated for hosting a computer program product which comprises executable instructions for performing the method in relationship with the spectrometer pixel array 144.

For further details with respect to the embodiment as schematically depicted in FIG. 2, reference may be made to the description of the embodiment as illustrated in FIG. 1 as provided above.

However, it is indicated here that, apart from the preferred exemplary embodiments of the device 110 according to the present invention as shown in FIG. 1 or 2, further embodiments of the device 110 may also be conceivable.

According to step a) of the method of the present invention, the incandescent lamp 116, such as schematically depicted in FIG. 1 or 2, which comprises the wire filament 114 which is designed for emitting the radiation 112 to be monitored is provided.

In accordance with step b) of the method of the present invention, the radiation sensitive element 124 which is designated for measuring the radiation 112 is further provided.

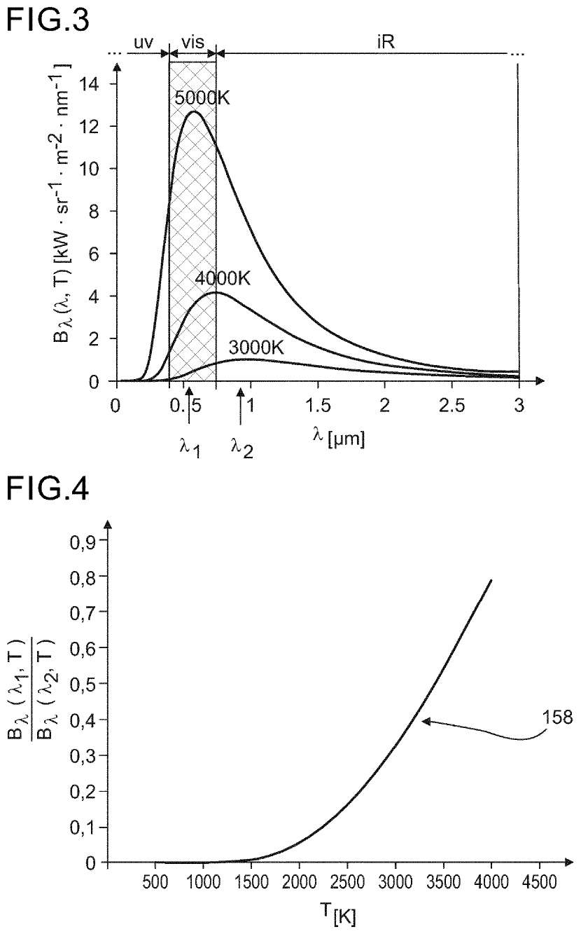

According to step c) of the method of the present invention, a spectral radiance B_{λ} of the radiation 112 which is emitted by the wire filament 114 of the incandescent lamp 116 is measured at two or more wavelengths. FIG. 3 illustrates, in a highly schematic fashion, the spectral radiance B_{λ} of the radiation 112 of wire filament 114 for the particular wavelength λ at various emission temperatures T of 3000 K, 4000 K, and 5000 K in accordance with Planck's law as defined by Equation (2) by

$${B}_{λ} ( λ , T ) = \frac{2 h {c}^{2}}{{λ}^{5}} \cdot \frac{1}{{e}^{\frac{h c}{λ {k}_{B} T}} - 1} , \qquad ( 2 )$$

wherein h is Planck's constant, c the speed of light, and k_{B} the Boltzmann constant. Thus, Planck's law provides a relationship between the spectral radiance B_{λ} of the radiation which is emitted by the wire filament 114 of the incandescent lamp 116 and the emission temperature T of the wire filament 114 over the ultraviolet (UV), visible (VIS) and infrared (IR) spectral ranges. Although Planck's law is based on the emission of a perfectly black body which, strictly speaking, does not exist in reality, the emission of a black surface as, for example, comprised by the wire filament 114 of the incandescent lamp 116 can be accurately approximated hereby in practice.

As a result of Equation (2), the spectral radiance B_{λ} of the wire filament 114 depends only on the wavelength λ of the radiation and the emission temperature T of the wire filament 114, thus, allowing a determination of the emission temperature T of the wire filament 114 of the incandescent lamp 116 by evaluating the spectral radiance B_{λ} of the radiation 112 for the one or, preferably, wavelengths λ according to step d) of the method of the present invention. Herein, a first wavelength λ₁ around 550 nm and a second wavelength λ₂ around 900 nm, respectively, are schematically indicated in FIG. 3 in accordance with the preferred example provided above in which the individual sensor regions 128 exhibit a high spectral sensitivity around these wavelengths λ₁, λ₂.

FIG. 4 illustrates, in a highly schematic fashion, experimental results which have been obtained by using the device 110 of FIG. 1 with two individual uniform sensor regions 128, wherein a first sensor region 128 was designed for measuring the spectral radiance B_{λ} of the radiation 112 emitted by the wire filament 114 of the incandescent lamp 116 at the first wavelength λ₁ of 520 nm, i.e. in the green part of the visible spectral range, and wherein a second sensor region 128 was designed for measuring the spectral radiance B_{λ} of the radiation 112 emitted by the wire filament 114 of the incandescent lamp 116 at the second wavelength λ₂ of 850 nm, i.e. in the near infrared spectral range, respectively.

As depicted in FIG. 4, the quotient

$$\frac{{B}_{λ} ( {λ}_{1} , T )}{{B}_{λ} ( {λ}_{2} , T )}$$

according to Equation (0.5) for λ₁=520 nm and for λ₂=850 nm can approximated in an accurate fashion by a polynomial function 158 according to Equation (4) as

$$\frac{{B}_{λ} ( {λ}_{1} , T )}{{B}_{λ} ( {λ}_{2} , T )} = - 9 \cdot {10}^{- 15} {T}^{4} + 9 \cdot {10}^{- 11} {T}^{3} + 2 \cdot {10}^{- 7} {T}^{2} + 2 \cdot {10}^{- 4} T + 0 , 433. \qquad ( 4 )$$

Moreover, the polynomial function 158 can within a temperature range of 1000 K to 4000 K be simplified into a polynomial of second order according to Equation (5) as

$$\frac{{B}_{λ} ( {λ}_{1} , T )}{{B}_{λ} ( {λ}_{2} , T )} = 1 \cdot {10}^{- 7} {T}^{2} + 3 \cdot {10}^{- 4} T + 0 , 168. \qquad ( 5 )$$

Herein, both polynomial functions according to Equations (4) and (5) are invertible and can, thus, be used as an inverted function

$$T ( \frac{{B}_{λ} ( {λ}_{1} , T )}{{B}_{λ} ( {λ}_{2} , T )} )$$

for determining emission temperature T of the wire filament 114 of the incandescent lamp 116 from the quotient.

### LIST OF REFERENCE NUMBERS

110 device
112 radiation
114 wire filament
116 incandescent lamp
118 bulb
120 volume
122 carrier
124 radiation sensitive element
126 radiation sensor
128 sensor region
130 evaluation device
132 interface
134 processing device
136 monitor
138 keyboard
140 spectrometer device
142 radiation sensitive array
144 spectrometer pixel array
146 radiation sensitive pixel
148 first beam path
150 object
152 diffractive element
154 second beam path
156 edge
158 polynomial function

1. A method for monitoring radiation emitted by a radiation emitting element of a thermal radiation source, wherein the method comprises the following steps:
a) providing a thermal radiation source comprising a radiation emitting element, wherein the radiation emitting element emits radiation to be monitored, wherein the radiation emitting element comprises a wire filament of an incandescent lamp or a radiation emitting surface of a thermal infrared emitter;
b) providing at least one radiation sensitive element, wherein the radiation sensitive element is designated for measuring the radiation emitted by the radiation emitting element;
c) measuring a spectral radiance of the radiation emitted by the radiation emitting element at at least two individual wavelengths; and
d) determining an emission temperature of the radiation emitting element by providing a ratio of the measured values of the spectral radiance of the radiation at the at least two individual wavelengths,
wherein the ratio of the measured values of the spectral radiance for the two of the individual wavelengths as a function of temperature is approximated by using a polynomial function of second order within a temperature range from 1000 K to 4000 K.

2. The method according to claim 1, wherein the spectral radiance of the radiation at the at least two individual wavelengths is evaluated by using Planck's law which provides a relationship between the spectral radiance of the radiation emitted by the radiation emitting element and the emission temperature of the radiation emitting element.

3. The method according to claim 1, wherein the emission temperature of the radiation emitting element is determined by comparing measured values for the spectral radiance at at least two of the individual wavelengths.

4. The method according to claim 3, wherein the ratio of the measured values of the spectral radiance for two of the individual wavelengths is a quotient of the measured values of the spectral radiance for the two individual wavelengths.

5. The method according to claim 1, wherein a first wavelength at which the spectral radiance is measured is selected from the group consisting of the visual spectral range, and wherein a second wavelength at which the spectral radiance is measured is selected from the group consisting of the near infrared spectral range.

6. The method according to claim 1, 1 wherein a relative spectral sensitivity of the radiation sensitive element at the at least two individual wavelengths is further taken into account when evaluating the spectral radiance of the radiation at the at least two individual wavelengths.

7. The method according to claim 1, wherein the spectral radiance of the radiation emitted by the radiation emitting element is measured at a single wavelength, wherein the emission temperature of the radiation emitting element is determined by comparing a measured value of the spectral radiance for the single wavelength with a known value of the spectral radiance for the single wavelength, wherein the known value for the spectral radiance is obtained in a calibration of the radiation sensitive element.

8. The method according to claim 7, wherein a known thermal radiation source having a known emission temperature of the radiation emitting element is used for the calibration of the radiation sensitive element, wherein the measuring of the spectral radiance of the radiation emitted by the radiation emitting element is performed in a same controlled environment in which the calibration of the radiation sensitive element is performed.

9. A computer program product which comprises executable instructions for performing the method according to claim 1.

10. A device for monitoring radiation emitted by a radiation emitting element of a thermal radiation source, wherein the radiation emitting element comprises a wire filament of an incandescent lamp or a radiation emitting surface of a thermal infrared emitter, wherein the device comprises:
at least one radiation sensitive element, wherein the radiation sensitive element is designated for measuring radiation which is emitted by the radiation emitting element of the thermal radiation source at at least two individual wavelengths; and
an evaluation device, wherein the evaluation device is designated for determining an emission temperature of the radiation emitting element by providing a ratio of the measured values of the spectral radiance of the radiation at the at least two individual wavelengths,
wherein the ratio of the measured values of the spectral radiance for the two of the individual wavelengths as a function of temperature is approximated by using a polynomial function of second order within a temperature range from 1000 K to 4000 K.

11. The device according to claim 10, wherein the evaluation device is designated for evaluating the spectral radiance of the radiation at the at least one wavelength by using Planck's law which provides a relationship between the spectral radiance of the radiation emitted by the radiation emitting element and the emission temperature of the radiation emitting element.

12. The device according to claim 10, wherein the radiation sensitive element comprises a radiation sensor having at least one sensor region, wherein the sensor region comprises a radiation sensitive material, wherein the radiation sensitive material is selected from the group consisting of silicon, indium gallium arsenide (InGaAs), indium arsenide (InAs), lead sulfide (PbS), lead selenide (PbSe), indium antimonide (InSb), and mercury cadmium telluride (MCT, HgCdTe).
